(19) United States
(12) Patent Application Publication
(10) Pub. No.: US 2026/0370671 A1
(43) Pub. Date: Nov. 19, 2026

(54) CLUSTER NODE ACTIVITY-BASED ANOMALY DETECTION FOR TELECOMMUNICATIONS OPERATOR CORE NETWORK FUNCTIONS

(71) Applicant: T-MOBILE INNOVATIONS LLC, Overland Park, KS (US)

(72) Inventor: Henry DELGADO, Centreville, VA (US)

(21) Appl. No.: 19/210,957

(22) Filed: May 16, 2025

(51) Int. Cl. H04L 9/40; H04L 41/16

(52) U.S. Cl. CPC H04L 63/1425; H04L 41/16

(57) ABSTRACT

In various examples, cluster node activity-based anomaly detection for telecommunications operator core network functions is presented. A Monitoring Traffic System (MTS) comprises a network function that communicates with nodes of the core network to gather information indicative of network function anomalies. The MTS detects anomalous behavior using statistical models to identify network failures occurring between nodes in a network cluster that are behaving inconsistently as compared to baseline network behaviors. The MTS may apply statistical models and parse through specific procedure transactions recorded as events in network node logs to identify anomalies. The MTS may operate in a first mode where it evaluates node data traffic logs when the core network is operating under normal conditions to predict a nominal baseline, and a second “monitoring” mode where the MTS statistically compares node data traffic logs from the nodes against the nominal baseline.

### BACKGROUND

Modern fifth-generation (5G) telecommunications core networks are often implemented using clusters of nodes that host one or more network functions (NFs) as virtualized network functions (VNFs). This core network architecture leverages network function virtualization (NFV) to deploy software-based network functions on shared physical infrastructure, enhancing flexibility and scalability. The 5G core network may be designed as a cloud-hosted service-based architecture, which allows for dynamic resource allocation and efficient management of network functions. Clusters in a 5G core network may include multiple nodes, each hosting different VNFs. These nodes can comprise physical servers, virtual machines, or containers, and they work together to provide the necessary network services. Examples of VNFs included in a 5G core network may include, but are not limited to, the Access and Mobility Management Function (AMF), Session Management Function (SMF), User Plane Function (UPF), Unified Data Management (UDM), and Policy Control Function (PCF). Each VNF performs specific tasks, such as managing user sessions, handling data traffic, and enforcing network policies. Nodes within a cluster can be dynamically scaled up or down based on network demand, allowing for efficient utilization of resources. The use of clusters to form a 5G core network facilitates high availability and reliability, as the failure of one node does not impact the overall network performance.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

In contrast to prior techniques, one or more embodiments of the Monitoring Traffic System (MTS) described herein provide a separate network function for a core network that communicates with the various other nodes of the core network to gather information that may be indicative of eminent network function issues. Embodiments discussed herein may consider the interactions between nodes of clusters that host NFs that may indicate precursor issues at the network node level that can manifest as issues that eventually cause degradation in the operations of the core network NFs. In some embodiments, a monitoring traffic system (MTS) is described that detects anomalous behavior using statistical models to quickly identify network failures occurring between two or more nodes in a cluster that are behaving inconsistently and/or as outliers when compared to baseline network behaviors. The MTS may use statistical models and parse through specific procedure transactions documented in network node logs to identify anomalies within the network. The MTS may read and analyze logs generated at the nodes that record events indicative of data traffic issues between the nodes of the cluster(s). As discussed herein, an MTS may initially operate in a first “initialization” mode where it evaluates node data traffic logs when the core network is operating under normal conditions to establish a nominal baseline, and then may switch to a second “monitoring” mode where the MTS statistically compares node data traffic logs from the nodes against the nominal baseline.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example network environment for a telecommunications network comprising a monitoring traffic system (MTS), in accordance with some embodiments described herein;

FIG. 2 is a diagram illustrating a network cluster comprising a plurality of network nodes that include a monitoring traffic system (MTS), in accordance with some embodiments described herein;

FIG. 3 is a diagram illustrating the determining of one or more anomalous behaviors based on one or more deviations in network data traffic behaviors, in accordance with some embodiments described herein;

FIG. 4 is a flow chart illustrating an example method for cluster node activity-based anomaly detection, in accordance with some embodiments described herein;

FIG. 5 is an example computing device, in accordance with some embodiments described herein; and

FIG. 6 is an example cloud computing platform, in accordance with some embodiments described herein.

### DETAILED DESCRIPTION

In the following detailed description, reference is made to the accompanying drawings that form a part hereof, and in which is shown by way of specific illustrative, embodiments in which the embodiments may be practiced. These embodiments are described in sufficient detail to enable those skilled in the art to practice the embodiments, and it is to be understood that other embodiments may be utilized and that logical, mechanical, and electrical changes may be made without departing from the scope of the present disclosure. The following detailed description is, therefore, not to be taken in a limiting sense.

One or more of the embodiments presented in the disclosure provide for, among other things, systems and methods for cluster node activity-based failure detection for telecommunications operator core network functions. Proposed embodiments may provide efficient responses to identified traffic pattern anomalies that may affect the operation of network functions of operator core networks, and in some embodiments, deploy and/or recommend fixes.

In the telecommunications industry, identifying issues that degrade core network performance or otherwise impact subscriber experience is important. Poor network quality can lead to increased operational costs, lost revenue, and subscriber discontent as operational costs rise along with network downtime caused by the need for frequent maintenance. The current approaches for discovering failures and degradations in 5G core networks involve capturing data directly from an NF data source (e.g., an NF log produced by the Access and Mobility Management Function (AMF), Session Management Function (SMF), and User Plane Function (UPF), etc.) and applying algorithms and/or machine learning techniques for anomaly detection to predict when that NF’s behavior indicates a degradation in operation. The data collected from the NF includes logs, entries, and metrics that may reflect when events are occurring that negatively impact network performance and/or customer experiences. The analysis of the collected data may be performed using data analytics platforms such as but not limited to Databricks, which run machine learning algorithms to detect anomalies within large datasets. However, these techniques tend to narrowly focus on data produced by the operation of individual NFs - which can miss more subtle anomaly indicators that involve interactions between NFs. Moreover, while evaluating NF logs entries provide insight into the operation of the NFs, such analysis may only begin to catch anomalous network events once those events begin to actually have an observable adverse impact on NF operations.

In contrast to prior techniques, one or more embodiments of the Monitoring Traffic System (MTS) described herein introduce a separate network function for a core network that communicates with the various other nodes of the core network to gather information that may be indicative of eminent network function issues. That is, embodiments discussed herein may consider the interactions between nodes of clusters that host NFs, which may indicate precursor issues at the network node level that can manifest as issues that eventually cause degradation in the operations of the core network NFs.

One or more embodiments of the present disclosure provide a monitoring traffic system (MTS) that detects anomalous behavior using statistical models to quickly identify network failures occurring between two or more nodes in a cluster that are behaving inconsistently and/or as outliers when compared to baseline network behaviors. The MTS makes use of statistical models and parses through specific procedure transactions documented in network node logs to identify anomalies within the network.

In some embodiments, an MTS may be implemented as a distinct network function within the core network (CN) that monitors data traffic between nodes of one or more clusters that host CN network functions. The MTS may be hosted on a separate node as a network function of the core network to act as central hub that communicates with the various NFs and the nodes that host those NFs. This independence may ensure that the MTS remains operational even if other specific NFs encounter issues.

The MTS may read and analyze logs generated at the nodes that record events indicative of data traffic issues between the nodes of the cluster(s). Breakdowns in data communication between the nodes of a cluster can affect the performance of network functions hosted on these nodes, particularly with respect to the ability of the NF to interact with each other to carry out network services associated with routine 5G network operations. Data traffic logs maintained by the nodes can include entries indicative of inbound and outbound data transmission (e.g., internet protocol (IP) packet) rates, dropped packet counts, latency metrics, effective bandwidth, timeouts, and corresponding events occurring in traffic between the nodes that host the CN network functions. In some embodiments, the MTS may use application programming interface (API) calls to pull data from multiple nodes of the cluster(s) in real-time, allowing for timely detection of anomalous behaviors and timely responses to deviations from normal operating conditions.

As discussed herein, an MTS may initially operate in a first “initialization” mode where it evaluates node data traffic logs when the core network is operating under normal conditions to establish a nominal baseline, and then may switch to a second “monitoring” mode where the MTS statistically compares node data traffic logs from the nodes against the nominal baseline.

With respect to operating in the initialization node, in some embodiments an MTS may include machine learning and other algorithms trained to generate a prediction of the baseline of data traffic indicators - such as indicators that are expected to appear in or are otherwise computable from data traffic logs under normal (e.g., non-degraded) network operating conditions. The MTS may monitor logs generated by the nodes of the cluster (e.g., for a predetermined initialization time period) to determine the types and frequencies of log entries that are expected for the nodes of each NF (e.g., a baseline for the node hosting the UPF, a baseline for a node hosting an AMF, etc.) and thus establish baseline for the cluster(s) implementing the CN under nominal operating conditions. For example, the MTS may use machine learning algorithms to create predictions of event entries that are expected to be found in log entries, and their expected frequencies of occurrence, under nominal conditions. That is, the MTS may use machine learning algorithms to establish a baseline of expected network behavior based on historical data. Under nominal core network operating conditions, the collected node log data may not necessarily be free from indications of network anomalies (e.g., dropped base station handovers, spontaneous user equipment (UE) disconnects, subscriber UE registration failures, etc.). However, the baseline data may instead provide an indication of the type and/or frequency of such network anomalies that are expected to normally occur.

Once the predicted baseline is established, the MTS may switch to its monitoring mode. While in monitoring mode, the MTS may holistically analyze the corpus of collected logs and computed metrics to identify problems, pinpointing the affected nodes and/or the nature of the impact on NFs. For example, the analysis may be performed by statistically comparing data obtained and/or derived from node data traffic logs for a second time period with the data obtained and/or derived from the nominal baseline. Deviations from the predicted values may be flagged by the MTS as potential issues.

Once a predicted baseline is established, the MTS may continuously monitor the data traffic between nodes of the cluster(s) in real-time. The MTS may compare the log entries being generated by the NFs and their corresponding nodes under the current operating conditions against the predicted baseline to detect deviations that exceed a predefined threshold. These deviations indicate potential anomalies or issues within the network, allowing the MTS to identify and address problems promptly. This approach may permit a network operator to maintain optimal core network performance and reliability by proactively detecting and selectively mitigating issues before they escalate.

The MTS may monitor a wide range of network functions (e.g., nodes that host the AMF, SMF, UPF, etc.) to obtain a broad view of the network, capturing data from multiple connected nodes and correlating information to detect complex issues. The parameters evaluated by the MTS to perform anomaly detection may vary and can include, for example, bandwidth, uptime, connections, latency, IP connections, and/or other failures. The flexibility of the MTS allows it to be tailored to specific needs, making it capable of monitoring a broad range of metrics and counters –providing adaptability for accurately detecting and addressing issues within the network. As a non-limiting example, the MTS may identify 5G core network anomalies such as a 5G to evolved packet system (EPS) core network UE handover failure by comparing real-time data against established predictions based on historical data and statistical models, such as standard deviation calculations. For example, if the MTS predicted baseline indicates that three of this type of UE handover failures per hour are normal, then in some embodiments no further action will be taken and the MTS will continue to monitor the network nodes. If instead the number of failures exceeds the predicted value, such as four or five failures per hour, the MTS may identify that the core network is experiencing a network anomaly, classify the type of network anomaly, and trigger an alarm (e.g., to network operators) and/or a corrective action based on the network anomaly classification. A remediation action may include sending alerts to operations or providing recommendations for corrective measures, ensuring appropriate responses to different types of issues. The MTS, based on identification of issues with nodes in a cluster, may offload or redirect the affected core network data traffic. If such auto-correction within the cluster(s) of the core network is not applicable, then one or more of the affected nodes may be taken out of service until further action is taken, either manually or remotely. The MTS functions to quickly identify nodes that are triggering a high number of network function failures, allowing network operators to optimize network performance and ensure continuous connectivity while minimizing subscriber impact.

The MTS may comprise an anomaly detector that executes one or more statistical models to detect anomalies and identify network failures between nodes in a cluster. In some embodiments, statistical models may be associated with one or more procedure transactions directed to distinct network operations. For example, one procedure transaction may involve an initial registration procedure for connecting and authenticating a UE with the 5G core. To perform a UE connection and authentication, an access and mobility management function (AMF) may handle UE registration and mobility management, an authentication server function (AUSF) may authenticate the UE using 5G authentication and key agreement (5G-AKA) or extensible authentication protocol-authentication and key agreement (EAP-AKA'), and a unified data management (UDM) may manage subscriber data, including authentication credentials (e.g., where the Authentication Credential Repository and Processing Function (ARPF) selects an authentication method based on subscriber identity and configured policy). When monitoring for initial registration anomalies, the MTS may execute a statistical model comprising an algorithm to parse through logs of nodes that host the AMF, AUSF, UDM, and/or other core network functions to identify statistical deviations between logged data (e.g., log entries occurring within a time window) and the corresponding expected logged data based on the baseline predictions.

Another procedure transaction may involve UE handover preparation for transferring a mobile UE from one base station cell to another. To perform a UE handover, the AMF may manage mobility (e.g., determining the target cell for a handover, coordinating handover procedures between the source and target base stations, etc.), the SMF may handle session management to ensure continuity of data traffic during the handover, and the policy control function (PCF) may apply policies related to handover and mobility management. When monitoring for UE handover anomalies, the MTS may execute a statistical model comprising an algorithm to parse through logs of nodes that host the AMF, SMF, PCF, and/or other core network functions to identify statistical deviations between logged data (e.g., log entries occurring within a time window) and the corresponding expected logged data based on the baseline predictions.

As another nonlimiting example, another procedure transaction may involve Packet Data Unit (PDU) session management. A PDU session comprises a logical connection between a UE and a data network (DN) and provides a user plane connection between the US and the DN. With respect to PDU session management, the session management function (SMF) may be responsible for creating, updating, and terminating PDU sessions; the user plane function (UPF) handles user data traffic and ensures efficient data routing within the PDU session; the Policy Control Function (PCF) provides session management policies; and the access and mobility management function (AMF) may handle connection and mobility aspects, forwarding session management requests to the SMF. In some instances, a network repository function (NRF) may assist the AMF in selecting an appropriate SMF for a UE. When monitoring for PDU management anomalies, the MTS may execute a statistical model comprising an algorithm to parse through logs of nodes that host the SMF, UPF, PCF, AMF, NRF, and/or other core network functions to identify statistical deviations between logged data (e.g., log entries occurring within a time window) and the corresponding expected logged data based on the baseline predictions.

In some embodiments, a statistical model executed by the anomaly detector of the MTS may include, but is not limited to, analysis of variance (ANOVA), t-tests, and/or standard deviation (STD) algorithms, for example. For example, an ANOVA algorithm may be executed to compare means between groups (e.g., current operating data from the logs versus baseline data), testing a null hypothesis that proposes there is no difference between groups against an alternative hypothesis that proposes there is at least one difference. In some embodiments, a threshold for statistical significance, α, is determined, which represents the probability of rejecting the null hypothesis when it is actually true. The ANOVA algorithm calculates the p-value, which measures the probability that the observed data would occur if the null hypothesis were true. If the p-value is larger than α, the null hypothesis is accepted. If the p-value is less than α, the null hypothesis is rejected, indicating a difference between groups. As such, if a p-value is less than α, then the MTS is executing an ANOVA-based statistical model for a given procedure transaction, and if the p-value is less than α, then the MTS may conclude that there is an operating anomaly involving the nodes that supports the network functions performing that procedure transaction –and may respond as described herein. In some embodiments, threshold criteria for triggering a response may be based on standard deviation measures. That is, the standard deviation measures a dispersion of data around the mean using a normal distribution curve (a curve symmetrical about the mean, with 68 % of data within one standard deviation, 95 % within two standard deviations, and 99 % within three standard deviations). In some embodiments, the MTS may consider an anomalous deviation from the baseline to be actional based on the statistical model meeting (e.g., exceeding) a threshold criterion, such as a standard deviation threshold. For example, the MTS may disregard anomalous behavior within two standard deviations of the predicted baseline, trigger a warning to network operators for anomalous behavior between two and three standard deviations of the predicted baseline, and in some embodiments trigger a corrective action (e.g., presenting recommended actions and/or automatically reinstating network functions onto different nodes) for anomalous behavior in excess of three standard deviations. It should be noted that these thresholds are described for example purposes, and in other embodiments, other trigger thresholds may be applied by the MTS, and different trigger thresholds may be applied to different procedure transactions. As such, a response by the MTS can be tiered based on the severity of the impact, with the system taking independent corrective actions for minor issues and alerting operations for more severe anomalies. In some embodiments, an MTS may correlate log data from multiple nodes for multiple network functions to detect complex issues that may not be evident from a single function's logs.

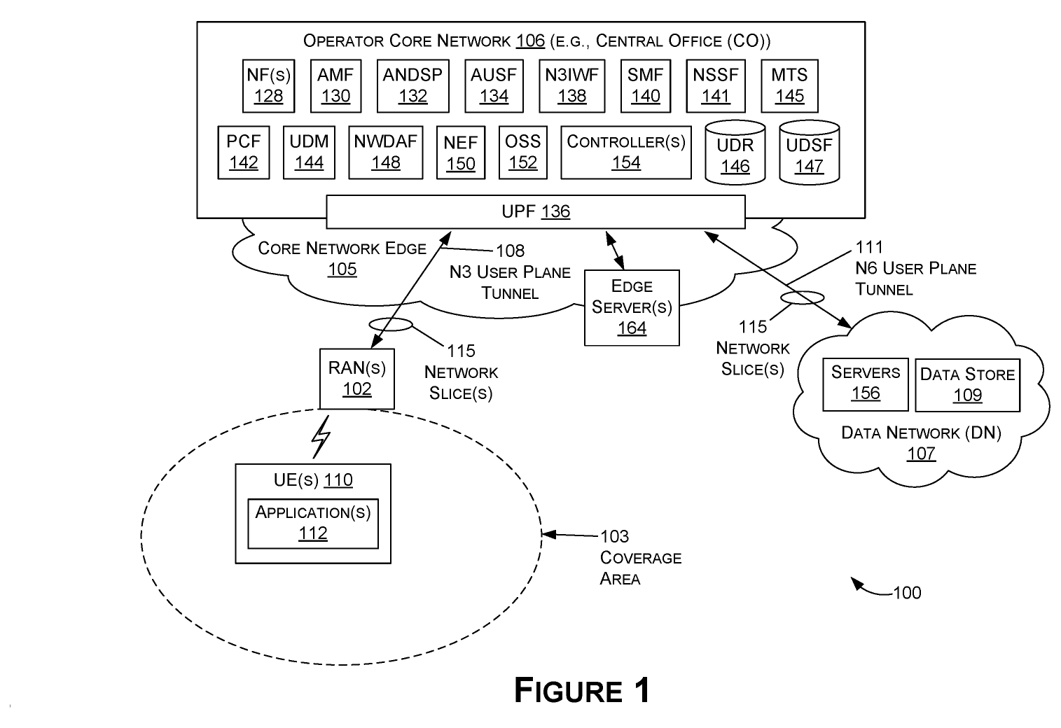

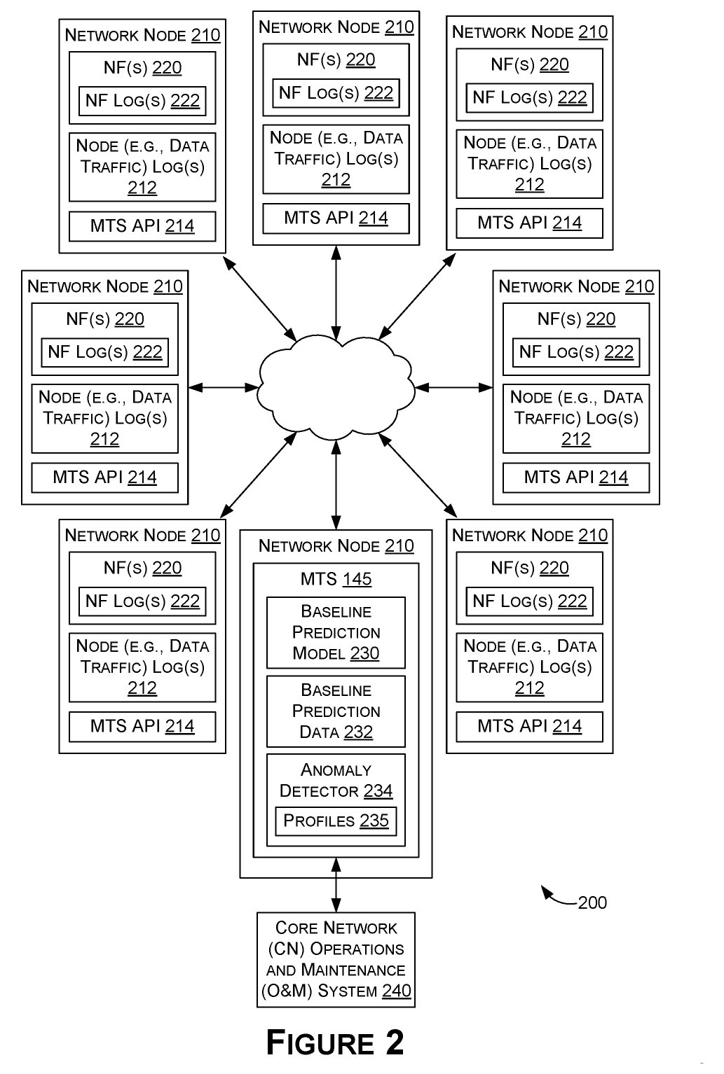

As further described below with respect to FIGS. 1 and 2, an MTS can monitor various network functions of the operator core network to provide a broad view of the network, capturing data from all connected systems. The MTS is configurable and not tied to any specific telecommunications standard or technology. That is, the MTS may be implemented for core networks of different network technologies, including 4G, 5G, 6G,Wi-Fi, and/or other standards.

In some embodiments, the MTS may implement an extended monitoring scope that monitors server logs of nodes for network functions hosted by edge servers and/or radio access networks (RAN). For example, in some cases a network operator may instantiate one or more network functions on an edge server, either on a short-term or long-term basis, to improve response times (e.g., reduce network function latency) or to provide relief from excess data traffic within the core network. Similarly, in some cases a network operator may instantiate one or more network functions on a network node server for the RAN in order – for example to better serve user equipment (UE) operating within the coverage area of the RAN using low-latency services. In such embodiments, the MTS may establish the nominal baseline for core network data traffic behavior by further evaluating node data traffic logs from the edge server(s) and/or RAN(s). Then in monitoring mode, the MTS may include those nodes in the set of nodes that it monitors by statistically comparing node data traffic logs from the nodes against the nominal baseline.

In some embodiments, an MTS can tailor its predicted baseline based on regional and/or market-specific variations, considering factors such as population density and subscriber numbers, to ensure that flagged anomalies represent true deviations from nominal conditions for different network environments. The Monitoring Traffic System (MTS) can adapt its predictions based on regional or market-specific variations. Different markets may have varying norms due to differences in population density and subscriber numbers, which affect the frequency of network failures. The MTS establishes predictions by analyzing data from each market separately, considering these unique characteristics. For instance, a larger market with more devices may have a higher baseline for failures compared to a smaller market. The system captures this data to create market-specific norms, and any deviations from these norms are flagged as anomalies.

In some embodiments, the baseline prediction may be updated regularly to account for changes in network conditions. For example, during events like festivals, an MTS may detect a spike in the number of failures occurring due to the increased network usage rather than degradation of the network itself. In such instances, an update to the baseline prediction may be initiated (e.g., by network operators) that would apply for the duration of the event. After the event, another update to the baseline prediction may be initiated (e.g., by network operators) so that the baseline again reflects normal network operation.

FIG. 1 is a diagram illustrating an example network environment 100 embodiment for a wireless communication system. Network environment 100 is but one example of a suitable telecommunications network and is not intended to suggest any limitation as to the scope of use or functionality of the embodiments disclosed herein, and nor should the network environment be interpreted as having any dependency or requirement relating to any one or combination of components illustrated. As shown in FIG. 1, network environment 100 comprises an operator core network 106 (also referred to as a “core network” or “CN”) that provides one or more network services to one or more UEs 110 (e.g., 3GPP (3rd Generation Partnership Project) UE) via at least one access network, such as radio access network (RAN) 102. In some embodiments, network environment 100 comprises, at least in part, a wireless communications network, such as, but not limited to, a 4G or 5G wireless communications network.

In some embodiments, the network environment 100 comprises one or more radio access networks (RANs) 102, which may be referred to in the context of a wireless telecommunications network as a wireless base station, cell site, or cellular base station. A RAN 102 may represent at least one wireless base station coupled to an operator core network to establish one or more communication links between the operator core network 106 and a user equipment (UE) 110. Each RAN may provide wireless connectivity access to one or more UEs operating within a coverage area 103 associated with that RAN 102. The RAN 102 may implement wireless connectivity using, for example, 3GPP technologies. The RAN 102 may be referred to as an eNodeB in the context of a 4G Long-Term Evolution (LTE) implementation, a gNodeB in the context of a 5G New Radio (NR) implementation, or other terminology depending on the specific implementation technology. In some embodiments, the RAN 102 may comprise, at least in part, components of a customer premises network, such as a distributed antenna system (DAS), for example. Radio access network(s) 102 may comprise a multimodal network (for example, comprising one or more multimodal access devices) where multiple radios supporting different systems are integrated into the radio access network(s) 102. Such a multimodal access network may support a combination of 3GPP radio technologies (e.g., 4G, 5G, and/or 6G) and/or non-3GPP radio technologies (e.g., Institute of Electrical and Electronics Engineers (IEEE) 802.11 (WiFi) and/or IEEE 802.15 (Bluetooth) access points). In some embodiments, the radio access network(s) 102 may comprise a terrestrial wireless communications base station and/or may be at least in part implemented as a space-based access network, such as a base station implemented by an Earth-orbiting satellite. An individual UE 110 may communicate with the operator core network 106 via the RAN 102 over one or both of uplink (UL) radio frequency (RF) signals and downlink (DL) radio frequency (RF) signals.

The radio access network(s) 102 may be coupled to the operator core network 106 via a core network edge 105 that comprises edge server nodes and wired and/or wireless network connections that may further include wireless relays and/or repeaters. In some embodiments, the RAN 102 may be coupled to the operator core network 106 at least in part by a backhaul network such as the Internet or other public or private network infrastructure. Core network edge 105 may comprise one or more network nodes (e.g., servers) or other elements of the operator core network 106 that may define the boundary of the operator core network 106 and may serve as the architectural demarcation point where the operator core network 106 connects to other networks such as, but not limited to, RAN 102, the Internet, Data Network (DN) 107, and/or other third-party networks. In some embodiments, the network edge 105 may comprise one or more network nodes that include edge server(s) 164. Edge server(s) 164 may provide, for example, edge-based services to UE 110 that may be accessed separately from services provided by network functions of the operator core network 106. For example, edge server(s) 164 may host databases, caches, microservices, ledgers, decentralized applications (e.g., DApps), and/or may perform data traffic monitoring, inspections, and/or aggregation for other network functions of the network environment 100.

It should be understood that in some aspects, the network environment 100 may not comprise a distinct operator core network 106, but rather may implement one or more features of the operator core network 106 within other portions of the network, or may not implement them at all, depending on various carrier preferences. As shown in FIG. 1, network environment 100 may also comprise at least one data network (DN) 107 coupled to the operator core network 106 (e.g., via the network edge 105). Data network 107 may include one or more data stores 109 and/or one or more content services servers 156. In some embodiments, UE 110 may access services and/or content provided by the data store(s) 109 and/or server(s) 156 of DN 107.

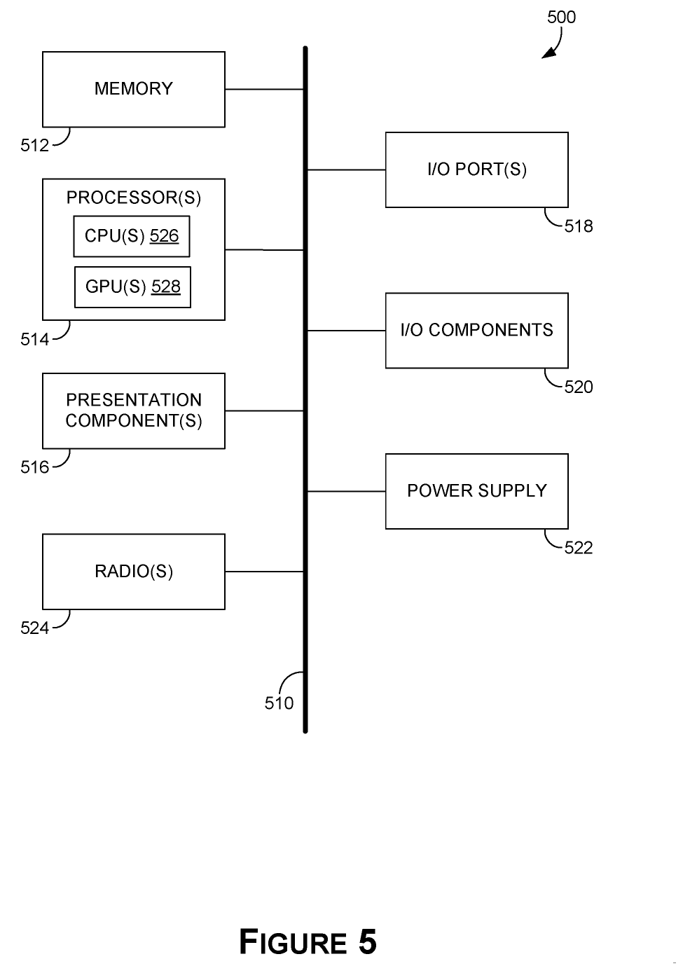

Generally, an individual UE 110 may comprise a device capable of unidirectional or bidirectional communication with the operator core network 106 via wireless and/or wired communication links. The network environment 100 may be configured for wirelessly connecting UEs 110 to other UEs 110 via the same access networks (e.g., RANs 102), via other access networks, via other telecommunications networks, and/or to connect UEs 110 to a public switched telecommunications network (PSTN). The network environment 100 may be generally configured, in some embodiments, for connecting UE 110 to data, content, and/or services that may be accessible from one or more application servers or other functions, nodes, or servers. In allocating network resources and access to these data or services, the operator core network 106 may instantiate one or more network slices 115 and allocate one or more of those slice(s) 115 to carry network traffic for one or more applications 112 executed by processors of the UE 110. UEs 110 are in general forms of equipment and machines such as, but not limited to, Internet-of-Things (IoT) devices and smart appliances, autonomous or semi-autonomous vehicles including cars, trucks, trains, aircraft, urban air mobility (UAM) vehicles and/or drones, industrial machinery, robotic devices, exoskeletons, manufacturing tooling, thermostats, locks, smart speakers, lighting devices, smart receptacles, controllers, mechanical actuators, remote sensors, weather or other environmental sensors, wireless beacons, cash registers, turnstiles, security gates, or any other smart device. That said, in some embodiments, UE 110 may include computing devices such as, but not limited to, handheld personal computing devices, cellular phones, smart phones, tablets, laptops, and similar consumer equipment, or stationary desktop computing devices, workstations, servers, and/or network infrastructure equipment. As such, the UE 110 may include both mobile UE and stationary UE. A UE 110 can include one or more processors and one or more non-transient computer-readable media for executing code to carry out the functions of the UE 110 described herein. The computer-readable media may include computer-readable instructions executable by the one or more processors. In some embodiments, the UE 110 may be implemented using a computing device 500, as discussed below with respect to FIG. 5.

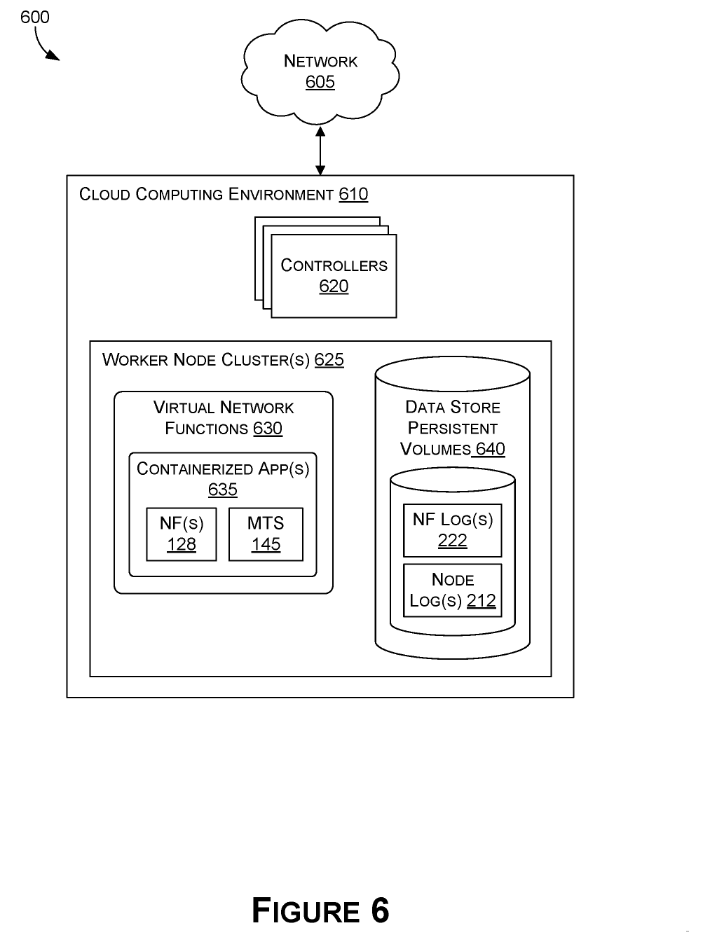

In some implementations, the operator core network 106 may comprise modules, also referred to as network functions (NFs), implemented by one or more processors and generally represented in FIG. 1 as NF(s) 128. As previously mentioned, one or more NFs of the operator core network 106 may be orchestrated as virtual network functions on nodes of one or more node clusters, such as but not limited to virtual network functions 630 of worker node cluster(s) 625 described in FIG. 6. Individual network functions that are distinctly illustrated in FIG. 1 may include, but are not limited to, one or more of a core access and mobility management function (AMF) 130, an access network discovery and selection policy (ANDSP) 132, an authentication server function (AUSF) 134, a user plane function (UPF) 136, non-3GPP interworking function (N3IWF) 138, a session management function (SMF) 140, a network slice selection function (NSSF) 141, a policy control function (PCF) 142, unified data management (UDM) 144, a unified data repository (UDR) 146, an unstructured data storage function (UDSF) 147, a network data analytics function (NWDAF) 148, a network exposure function (NEF) 150, and/or an operations support system (OSS) 152. As described herein, the operator core network 106 may include a network function comprising a monitoring traffic system (MTS) 145. The implementation of these NFs of the operator core network 106 may be executed by one or more controllers 154 on which these network functions are orchestrated or otherwise configured to execute utilizing processors and memory of the one or more controllers 154. The NFs may be implemented as physical and/or virtual network functions, container network functions, and/or cloud-native network functions, such as is described with respect to FIG. 6. Within the context of network slice(s) 115 created by the operator core network 106, the operator core network 106 may orchestrate individual dedicated instances of one or more network functions to establish and support operation of a network slice 115.

Notably, the nomenclature used herein is used primarily with respect to the 3GPP 5G architecture. In other aspects, one or more of the network functions of the operator core network 106 may take different forms, including consolidated or distributed forms that perform the same general operations. For example, the AMF 130 in the 3GPP 5G architecture may be configured for various functions relating to security and access management and authorization, including registration management, connection management, paging, and mobility management. In other forms, such as a 4G architecture, the AMF 130 of FIG. 1 may take the form of a mobility management entity (MME). The operator core network 106 may be generally said to authorize rights to and facilitate access to an application server/service, such as provided by application function(s) requested by one or more UEs, such as UE 110. In some embodiments, the NSSF 141 works in conjunction with the AMF 130 to establish network slice instances of network slice(s) 115.

As shown in FIG. 1, UPF 136 represents at least one function of the operator core network 106 that may extend into the core network edge 105. In some embodiments, the RAN 102 is coupled to the UPF 136 within the core network edge 105 by a communication link that includes an N3 user plane tunnel 108. For example, the N3 user plane tunnel 108 may connect a cell site router of the RAN 102 to an N3 interface of the UPF 136. The data store(s) 109, server(s) 156, and/or other elements of DN 107 may be coupled to the UPF 136 in the core network edge 105 by an N6 user plane tunnel 111. For example, the N6 user plane tunnel 111 may connect a network interface (e.g., a switch, router, and/or gateway) of the DN 107 to an N6 interface of the UPF 136. In some embodiments, the operator core network 106 may comprise a plurality of UPFs 136, such as a UPF at the operator core network 106 and a UPF at the core network edge 105. For example, a UPF at the core network edge 105 may be used for local breakout and/or low-latency types of application via an N9 interface between the distinct UPFs.

The AMF 130 facilitates mobility management, registration management, and connection management for 3GPP devices, such as a UE 110. ANDSP 132 facilitates mobility management, registration management, and connection management for non-3GPP devices (e.g., devices that connect via the N3IWF 138). AUSF 134 may receive authentication requests from the AMF 130 and interacts with UDM 144, for example, for subscriber identification module (SIM) authentication and/or to authenticate a UE 110 based on a device identification (ID). N3IWF 138 provides a secure gateway for non-3GPP network access, which may be used for providing connections for UE 110 access to the operator core network 106 over a non-3GPP access network (e.g., via a data link established between a customer premise gateway and the N3IWF 138). SMF module 140 facilitates initial creation of protocol data unit (PDU) sessions with UE 110 using session establishment procedures. The PCF 142 maintains and applies policy control decisions and subscription information. Additionally, in some aspects, the PCF 142 maintains quality-of-service (QoS) policy rules. For example, the QoS rules stored in a unified data repository (UDR) 146 can identify a set of access permissions, resource allocations, or any other QoS policy established by an operator. The unstructured data storage function (UDSF) 147 may store dynamic state data, which is structured and unstructured data related to network function of the operator core network 106. That is, the UDSF 147 may support storage and retrieval of structured and/or unstructured data by other network functions 128 of the operator core network 106, including information relating to access control and service and/or microservice subscriptions.

In some embodiments, the PCF 142 maintains subscription information indicating one or more services and/or microservices subscribed to by each UE 110. The UDM 144 manages network user data including, but not limited to, data storage management, subscription management, policy control, and core network 106 exposure. NWDAF 148 collects data (for example, from UE; other network functions; application functions; and operations, administration, and maintenance (OAM) systems) that can be used for network data analytics. The OSS 152 is responsible for the management and orchestration of one or more elements of the operator core network 106 and the various physical, virtual network functions, container network functions, controllers, computer nodes, and other elements that implement the operator core network 106. In some embodiments, one or more instances for an MTS, such as the MTS 145 described herein may be orchestrated on one or more nodes of the core network 106 by OSS 152.

Some aspects of network environment 100 include the UDR 146 storing information relating to access control and service and/or microservice subscriptions. The UDR 146 may be configured to store information relating to such subscriber information and may be accessible by multiple different network functions (NFs) 128 in order to perform desirable functions. For example, the UDR 146 may be accessed by the AMF 130 in order to determine subscriber information pertaining to the UE 110 (e.g., which network slices the UE 110 is subscribed to use), accessed by a PCF 142 to obtain policy-related data, and/or accessed by NEF 150 to obtain data that is permitted for exposure to third-party applications (such as applications 112 executed by UE 110, for example). Other functions of the NEF 150 include monitoring of UE-related events and posting information about those events for use by external entities, and providing an interface for provisioning UEs 110 (e.g., via PCF 142) and reporting provisioning events to the UDR 146. Although depicted as a unified data management module, UDR 146 can be implemented as a plurality of network function specific data management modules. The operator core network 106 may orchestrate individual instances of each of these network functions and other such network functions described herein.

The UPF 136 is generally configured to facilitate user plane operation relating to packet routing and forwarding, interconnection to a data network (e.g., DN 107), policy enforcement, and data buffering, among other operations. Using network slicing (e.g., based on 5G software-defined networking managed by the 5G network slice selection function (NSSF) 141), the UPF 136 may establish a dedicated slice network function for one or more data channels between various network functions and other entities that act as, in essence, a distinct network (for example, establishing its own QoS, provisioning, and/or security) within the same physical network architecture of network environment 100. In some embodiments, the NSSF 141, either alone or in conjunction with other network functions ofthe operator core network 106, may function as a slice coordination network function to control the operator core network 106 to orchestrate individual dedicated instances of one or more of the network functions described herein to establish and support operation of network slices allocated to the UE 110.

FIG. 2 is a diagram illustrating a network cluster 200 comprising a plurality of network nodes 210, wherein individual nodes host (e.g., execute software to instantiate) one or more NFs 220, such as but not limited to any of the NFs that implement network functions of an operator core network 106 as described with respect to FIG. 1. In some embodiments, one or more of the network nodes 210 may comprise computing devices such as computing device 500 described with respect to FIG. 5. In some embodiments, network cluster 200 may at least in part be implemented on a cloud computing platform, such as the cloud computing environment 600 described with respect to FIG. 6. One or more of the network nodes 210 may comprise nodes of a worker node cluster 625 whereon the NFs 220 are orchestrated as instances of virtual network functions 630 and/or containerized application(s) 635 as described with respect to FIG. 6. Each network node 210 may generate and store one or more node log(s) 212 that record network events, data traffic statistics, and/or other information (e.g., interactions with other nodes 210) for that respective network node 210. Moreover, each NF 220 may individually generate and store one or more NF log(s) 222 that record network function events, data traffic statistics, and/or other information (e.g., interactions with other NFs) for that respective NF 220. In some embodiments, individual network nodes 210 may comprise an MTS API 214 that the MTS 145 may query to obtain data from the node log(s) 212 and/or NF log(s) 222.

Individual network nodes 210 of the network cluster 200 may comprise its own processing power, memory, and storage, and may communicate with the other network nodes 210 through the infrastructure of the operator core network 106. Resources of the network nodes 210 may be managed by the OSS 152, which may assign network functions 220 to nodes 210 based on, for example, capabilities of each node. Implementation of the NFs 220 as virtualized network functions (VNFs) nay be implemented using network cluster 200 by decoupling network services from dedicated hardware and running them as software instances on virtual machines (VMs) within the cluster. These VNFs may be managed by the OSS 152, to automate the provisioning, scaling, and lifecycle management of one or more of the NFs 220 as VNFs.

As shown in FIG. 2, in some embodiments the network cluster 200 may further include at least one network node 210 that hosts the MTS 145. In some embodiments, the MTS comprises a baseline prediction model 230, a memory that stores baseline prediction data 232, and/or an anomaly detector 234. To initialize the MTS 145, the MTS 145 may operate in a first “initialization” mode where the baseline prediction model 230 evaluates node data traffic logs 212 and/or NF log(s) 222 under conditions where the operator core network 106 is considered as operating under normal conditions (e.g., no actively known system degradation). The baseline prediction model 230 may include machine learning and other algorithms trained to generate baseline prediction data 232. The baseline prediction data 232 may comprise one or more predictions of baseline indicators -indicators of events, data traffic measurements, and/or statistics, etc., that are expected to appear in or are otherwise computable from node data traffic logs 212 and/or NF log(s) 222 under normal (e.g., non-degraded) network operating conditions. It should be noted that in some embodiments, the baseline prediction data 232 may include predictions based on node data traffic logs 212 and/or NF log(s) 222 of the network node 210 that hosts the MTS 145.

The anomaly detector 234 may execute one or more statistical models and/or machine learning models trained to detect anomalies and identify network failures between the network node 210 in the cluster 200 based on comparing the baseline prediction data 232 with current data obtained from data traffic logs 212 and/or NF log(s) 222. The statistical models may be associated with one or more procedure transactions directed at distinct network operations. For example, the anomaly detector 234 may include, or have access to, one or more procedure transaction profiles 235 that indicate the nodes 210 and/or NFs 220 of the cluster 200 associated with a procedure transaction and that define the statistical models to be executed (and may include corresponding response thresholds) for monitoring the nodes 210 for anomalies that may affect those procedure transactions, or indicate problems occurring with those associated network functions. In some embodiments, the anomaly detector 234 may correlate log data from multiple nodes 210 for multiple network functions 220 to detect complex issues that may not be evident from a single function's logs.

As previously discussed, procedure transactions may include one or more of, but are not limited to, initial registration procedures, UE handover preparation procedures, PDU session management procedures, and other transactions performed by elements of the operator core network 106. The anomaly detector 234 may parse through logs of nodes 210 that host the network functions 220 to identify statistical deviations between logged data (e.g., log entries occurring within a time window) and the corresponding expected baseline prediction data 232. In some embodiments, a statistical model executed by the anomaly detector 234 may include, but is not limited to, analysis of variance (ANOVA), t-tests, or another statistical algorithm for determining deviations and/or outlier data from datasets. In some embodiments, thresholds for triggering a response may be based on standard deviation measures and/or z-score statistics. Response by the MTS 145 based on anomalies detected by the anomaly detector 234 can be tiered based on the severity of the impact, with the system taking independent corrective actions for minor issues and alerting operations for more severe anomalies. In some embodiments, anomaly detector 234 may correlate log data from multiple nodes for multiple network functions to detect complex issues that may not be evident from a single function's logs.

In some embodiments, the MTS 145 may generate an output (e.g., an alert message) to the operation and maintenance (O&M) system 240 that monitors the health and operations of the operator core network 106. In some embodiments, the MTS 145 may disregard anomalous behavior indicating deviations less than a first threshold (e.g., within two standard deviations of the predicted baseline). In some embodiments, the MTS 145 may send a warning message to the core network O&M system 240 for anomalous behavior involving deviations greater than the first threshold criteria (e.g., exceeding two standard deviations of the predicted baseline) to alert system operators of the condition. The warning message may include, for example, an identification of the nodes 210 and/or NFs 220 involved in the deviations, and in some embodiments may indicate an associated procedure transaction potentially affected. In some embodiments, the MTS 145 may send an elevated warning message to the core network O&M system 240 for anomalous behavior involving deviations greater than a second threshold beyond the first threshold criteria (e.g., exceeding three standard deviations of the predicted baseline). The elevated warning message may trigger a corrective action such as presenting recommended actions and/or operations for automatically reinstating network functions onto different nodes or other actions. That is, the warning message to the core network O&M system 240 may trigger the telecommunications network to adjust operation of at least one of the plurality of network nodes 210 based on the one or more anomalous behaviors. It should be noted that other trigger thresholds may be applied by the MTS 145, and different trigger thresholds may be applied for different procedure transactions. A response to the O&M system 240 from the MTS 145 can be tiered based on the severity of the impact of the detected anomaly.

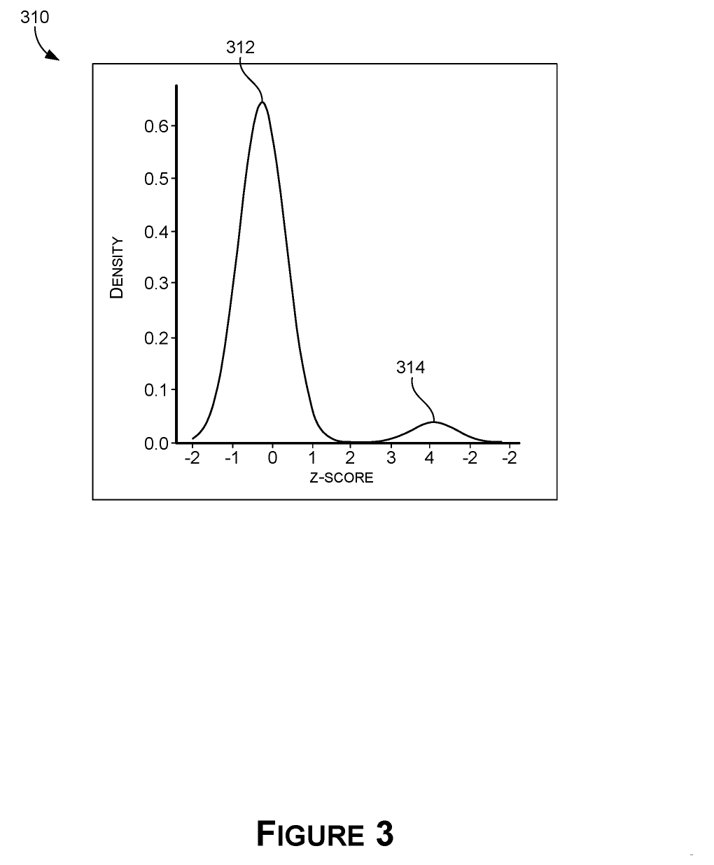

FIG. 3 is a diagram illustrating the determining of one or more anomalous behaviors based on one or more deviations in network data traffic behaviors, in accordance with some embodiments described herein. For example, FIG. 3 at 310 illustrates a statistical model standard deviation (computed as a z-score) for network data traffic behaviors captured by an AMF network function indicative of handover failure messages received in response to handover request messages that are components of a UE handover procedure transaction. As shown at 312, the majority of cell sites exhibit a deviation in baseline predictions of network data traffic behaviors that fall within a z-score of -1.5 to 1.5. However, as shown at 314, at least one cell site presents an outlier with a z-score of approximately 4, indicating an anomalous deviation from the baseline predictions. In some embodiments, the trigger threshold associated with a UE handover procedure transaction may be established at a z-score of 2.0 so that this example would trigger the MTS 145 to generate a message output to the O&M system 240 comprising either an alert or triggering the operator core network 106 to make one or more adjustments to the nodes 210 of network functions 220 involved in the UE handover procedure transactions associated with the affected cell site.

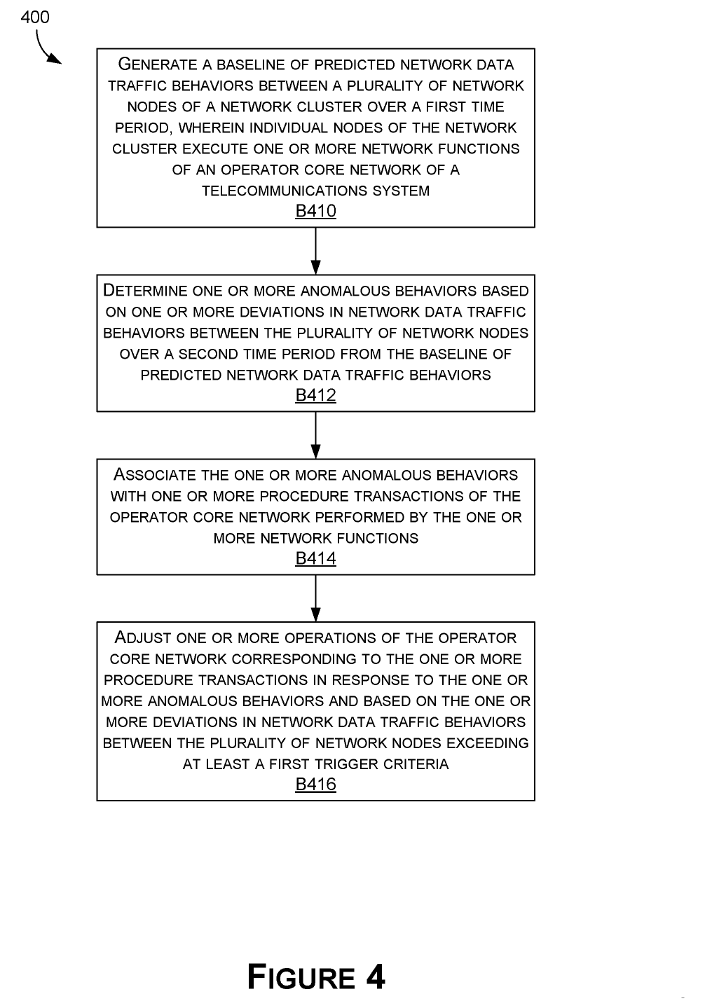

FIG. 4 is a flow chart illustrating a method 400 for cluster node activity-based anomaly detection, according to some embodiments. It should be understood that the features and elements described herein with respect to the method of FIG. 4 may be used in conjunction with, in combination with, or substituted for elements of any of the other embodiments discussed herein and vice versa. Further, it should be understood that the functions, structures, and other descriptions of elements for embodiments described in FIG. 4 may apply to like or similarly named or described elements across any of the figures and/or embodiments described herein and vice versa. In some embodiments, elements of method 400 are implemented utilizing one or more processing units comprising processing circuitry, such as the controller of an operator core network, an edge server, a RAN, and/or other processing units, as disclosed in any of the embodiments herein. In some embodiments, the method 400 may be implemented by components of a telecommunications network environment 100, such as illustrated by FIG. 1. In some embodiments, the method may be performed at least in part by an MTS network function of the operator core network 106, such as the MTS 145 discussed above with respect to FIGS. 1 and 2.

The method 400 at B410 includes generating a baseline of predicted network data traffic behaviors between a plurality of network nodes of a network cluster over a first time period, wherein individual nodes of the network cluster execute one or more network functions of an operator core network of a telecommunications system. As described herein, an operator core network 106 for a telecommunications network may include a network function comprising a monitoring traffic system (MTS) 145. In some embodiments, the MTS comprises a baseline prediction model 230, a memory that stores baseline prediction data 232, and/or an anomaly detector 234. To initialize the MTS 145, the MTS 145 may operate in a first “initialization” mode where the baseline prediction model 230 evaluates node data traffic logs 212 and/or NF log(s) 222 under conditions where the operator core network 106 is considered as operating under normal conditions (e.g., no actively known system degradation). The baseline prediction model 230 may include machine learning and other algorithms trained to generate baseline prediction data 232. The baseline prediction data 232 may comprise one or more predictions of baseline indicators - indicators of events, data traffic measurements and/or statistics, etc., that are expected to appear in or are otherwise computable from node data traffic logs 212 and/or NF log(s) 222 under normal (e.g., non-degraded) network operating conditions. It should be noted that in some embodiments, the baseline prediction data 232 may include predictions based on node data traffic logs 212 and/or NF log(s) 222 of the network node 210 that hosts the MTS 145.

The method 400 at B412 includes determining one or more anomalous behaviors based on one or more deviations in network data traffic behaviors between the plurality of network nodes over a second time period from the baseline of predicted network data traffic behaviors. The anomaly detector 234 may execute one or more statistical models and/or machine learning models trained to detect anomalies and identify network failures between the network node 210 in the cluster 200 based on comparing the baseline prediction data 232 with current data obtained from data traffic logs 212 and/or NF log(s) 222. The statistical models may be associated with one or more procedure transactions directed at distinct network operations. For example, the anomaly detector 234 may include, or have access to, one or more procedure transaction profiles 235 that indicate the nodes 210 and/or NFs 220 of the cluster 200 associated with the procedure transaction and that define the statistical models to be executed (and may include corresponding response thresholds) for monitoring the nodes 210 for anomalies that may affect those procedure transactions, or indicate problems occurring with those associated network functions. In some embodiments, the anomaly detector 234 may correlate log data from multiple nodes 210 for multiple network functions 220 to detect complex issues that may not be evident from a single function's logs. As previously discussed, procedure transactions may include one or more of, but are not limited to, initial registration procedures, UE handover preparation procedures, PDU session management procedures, and other transactions performed by elements of the operator core network 106. The anomaly detector 234 may parse through logs of nodes 210 that host the network functions 220 to identify statistical deviations between logged data (e.g., log entries occurring within a time window) and the corresponding expected baseline prediction data 232. In some embodiments, a statistical model executed by the anomaly detector 234 may include, but is not limited to, analysis of variance (ANOVA), t-tests, or another statistical algorithm for determining deviations and/or outlier data from datasets.

The method 400 at B414 includes associating the one or more anomalous behaviors with one or more procedure transactions of the operator core network performed by the one or more network functions. As described herein, MTS 145 may make use of statistical models and parse through specific procedure transactions documented in network node logs to identify anomalies within the network. In some embodiments, statistical models may be associated with one or more procedure transactions directed to distinct network operations. As a non-limiting example, one procedure transaction may involve an initial registration procedure for connecting and authenticating a UE with the 5G core; another procedure transaction may involve UE handover preparation; and another procedure transaction may involve Packet Data Unit (PDU) session management. Other procedure transactions may involve other operations and/or processes performed by the operator core network. It should be noted that different trigger thresholds may be applied by the MTS, and different trigger thresholds may be applied to different procedure transactions.

The method 400 at B416 includes adjusting one or more operations of the operator core network corresponding to the one or more procedure transactions in response to the one or more anomalous behaviors and based on the one or more deviations in network data traffic behaviors between the plurality of network nodes meeting at least a first trigger threshold.

In some embodiments, thresholds for triggering a response may be based on standard deviation measures and/or z-score statistics. Response by the MTS 145 based on anomalies detected by the anomaly detector 234 can be tiered based on the severity of the impact, with the system taking independent corrective actions for minor issues and alerting operations for more severe anomalies. In some embodiments, anomaly detector 234 may correlate log data from multiple nodes for multiple network functions to detect complex issues that may not be evident from a single function's logs. In some embodiments, the MTS 145 may generate an output (e.g., an alert message) to the operation and maintenance (O&M) system 240 that monitors the health and operations of the operator core network 106. In some embodiments, the MTS 145 may disregard anomalous behavior indicating deviations less than a first threshold (e.g., within two standard deviations of the predicted baseline). In some embodiments, the MTS 145 may send a warning message to the core network O&M system 240 for anomalous behavior involving deviations greater than the first threshold criteria (e.g., exceeding two standard deviations of the predicted baseline) to alert system operators of the condition. The warning message may include, for example, an identification of the nodes 210 and/or NFs 220 involved in the deviations, and in some embodiments may indicate an associated procedure transaction potentially affected. In some embodiments, the MTS 145 may send an elevated warning message to the core network O&M system 240 for anomalous behavior involving deviations greater than a second threshold beyond the first threshold criteria (e.g., exceeding three standard deviations of the predicted baseline). The elevated warning message may trigger a corrective action such as presenting recommended actions and/or operations for automatically reinstating network functions onto different nodes or other actions. That is, the warning message to the core network O&M system 240 may trigger the telecommunications network to adjust operation of at least one of the plurality of network nodes 210 based on the one or more anomalous behaviors. It should be noted that other trigger thresholds may be applied by the MTS 145, and different trigger thresholds may be applied for different procedure transactions. A response to the O&M system 240 from the MTS 145 can be tiered based on the severity of the impact of the detected anomaly.

Referring to FIG. 5, a diagram is depicted of an exemplary computing environment suitable for use in implementations of the present disclosure. In particular, the exemplary computer environment is shown and designated generally as computing device 500. Computing device 500 is but one example of a suitable computing environment and is not intended to suggest any limitation as to the scope of use or functionality of the embodiments described herein, and nor should computing device 500 be interpreted as having any dependency or requirement relating to any one or combination of components illustrated. In various embodiments, one or more aspects of an MTS 145 (e.g., baseline prediction model 230, baseline prediction data 232, and/or anomaly detector 234), as described herein, may be implemented at least in part using a computing device 500.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 5, computing device 500 includes bus 510 that directly or indirectly couples the following devices: memory memory 512, one or more processors 514, one or more presentation components 516, input/output (I/O) ports 518, I/O components 520, power supply 522, and radio 524. Bus 510 represents what may be one or more buses (such as an address bus, data bus, or combination thereof). The devices of FIG. 5 are shown with lines for the sake of clarity. However, it should be understood that the functions performed by one or more components of the computing device 500 may be combined or distributed amongst the various components. For example, a presentation component such as a display device may be one of I/O components 520. In some embodiments, one or more functions of MTS 145, as described herein, may be executed at least in part by computing device 500. The processors 514 of computing device 500 may include a memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” “smart television,” etc., as all are contemplated within the scope of FIG. 5 and refer to “computer” or “computing device.”

Computing device 500 typically includes a variety of one or more computer-readable media storing computer-usable instructions. For example, applications, algorithms, and/or neural networks may be stored in a memory comprising such computer-readable media. Computer-readable media can be any available media that can be accessed by computing device 500 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules, or other data.

Computer storage media includes non-transient random-access memory (RAM), read-only memory (ROM), electrically erasable programmable read-only memory (EEPROM), flash memory or other memory technology, compact disk (CD)-ROM, digital versatile disks (DVDs) or other optical disk storage, magnetic cassettes, magnetic tape, magnetic disk storage, or other magnetic storage devices. Computer storage media and computer-readable media do not comprise a propagated data signal or signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer-readable media.

Memory 512 includes computer storage media in the form of volatile and/or non-volatile memory. Memory 512 may be removable, non-removable, or a combination thereof. Exemplary memory includes solid-state memory, hard drives, optical-disc drives, etc. Computing device 500 includes one or more processors 514 that comprise processing circuitry and that read data from various entities such as bus 510, memory 512, and/or I/O components 520. Processors 514 may include one or more central processing units (CPUs) 526, and/or one or more graphics processing units (GPUs) 528, and/or other processing circuitry. In some embodiments, one or more functions of MTS 145 (e.g., baseline prediction model 230, baseline prediction data 232, and/or anomaly detector 234), as described herein, may include software code executed on CPUs 526 and/or GPUs 528. One or more presentation components 516 present data indications to a person or other device. Exemplary one or more presentation components 516 include a display device, speaker, printing component, vibrating component, etc. I/O ports 518 allow computing device 500 to be logically coupled to other devices including I/O components 520, some of which may be built into computing device 500. Illustrative I/O components 520 include a microphone, joystick, game pad, satellite dish, scanner, printer, wireless device, etc. In some embodiments, the I/O components 520 may include a network interface card (NIC) for coupling to a network, such as is described herein.

Radio(s) 524 represents a radio that facilitates communication with a wireless telecommunications network (such as telecommunications network environment 100). For example, radio(s) 524 may be used to establish communications with components of an access network (e.g., RAN 102), operator core network 106, and/or core network edge 105. Illustrative wireless telecommunications technologies include code-division multiple access (CDMA), general packet radio service (GPRS), time-division multiple access (TDMA), global system for mobile communications (GSM), and the like. Radio(s) 524 may additionally or alternatively facilitate other types of wireless communications including Wi-Fi, WiMAX, LTE, and/or other voice-over-internet protocol (VoIP) communications. In some embodiments, radio(s) 524 may support multimodal connections that include a combination of 3GPP radio technologies (e.g., 4G, 5G, and/or 6G) and/or non-3GPP radio technologies. As can be appreciated, in various embodiments, radio(s) 524 can be configured to support multiple technologies, and/or multiple radios can be utilized to support multiple technologies. In some embodiments, the radio(s) 524 may support communicating with an access network comprising a terrestrial wireless communications base station and/or a space-based access network (e.g., an access network comprising a space-based wireless communications base station). A wireless telecommunications network might include an array of devices, which are not shown so as to not obscure more relevant aspects of the embodiments described herein. Components such as a base station, a communications tower, or even access points (as well as other components) can provide wireless connectivity in some embodiments.

Referring to FIG. 6, a diagram is depicted generally at 600 of an exemplary cloud computing environment 610 for implementing one or more aspects of cluster node activity-based anomaly detection, as implemented by the systems and methods described herein. Cloud computing environment 610 is but one example of a suitable cloud computing environment and is not intended to suggest any limitation as to the scope of use or functionality of the embodiments presented herein, and nor should cloud computing environment 610 be interpreted as having any dependency or requirement relating to any one or combination of components illustrated. In some embodiments, the cloud computing environment 610 is coupled to a network 605 and/or may be executed within operator core network 106, the core network edge 105, edge server 164, or is otherwise coupled to the core network edge 105 or operator core network 106.

Cloud computing environment 610 includes one or more controllers 620 comprising one or more processors and memory. The controllers 620 may comprise servers of a data center. In some embodiments, the controllers 620 are programmed to execute code to implement at least one or more aspects of network environment 100, operator core network 106, and/or MTS 145 (e.g., baseline prediction model 230, baseline prediction data 232, and/or anomaly detector 234), as described herein. For example, in one embodiment, MTS 145 and/or any of the network functions 128 of the operator core network 106, core network edge 105, and/or RAN 102 as discussed herein may be implemented as one or more virtual network functions (VNFs) 630, which may include one or more container network functions (CNFs) running on a worker node cluster 625 established by the controllers 620.

The cluster of worker nodes 625 may include one or more orchestrated Kubernetes (K8s) pods that realize one or more containerized applications 635. For example, NF(s) 128 and/or MTS 145 may be implemented as containerized applications 635. In other embodiments, another orchestration system may be used. For example, the worker nodes 625 may use lightweight Kubernetes (K3s) pods, Docker Swarm instances, and/or other orchestration tools. In some embodiments, one or more elements of the telecommunications network environment 100 may be implemented by, or coupled to, the controllers 620 of the cloud computing environment 610 by operator core network 106, and/or core network edge 105. In some embodiments, one or more elements of procedure transaction profiles 235, NF log(s) 222, and/or node data traffic logs 212 may be implemented at least in part using one or more data store persistent volumes 640 in the cloud computing environment 610.

In various alternative embodiments, system and/or device elements, method steps, or example implementations described throughout this disclosure (such as the UE, network nodes, servers, access networks, core network edge, operator core network, network functions, and/or any of the sub-parts thereof, for example) may be implemented at least in part using one or more computer systems, field-programmable gate arrays (FPGAs), application-specific integrated circuits (ASICs), or similar devices comprising a processor coupled to a memory and executing code to realize the elements and/or processes, with said code stored on a non-transient hardware data storage device. Therefore, other embodiments of the present disclosure may include elements comprising program instructions resident on computer-readable media that when implemented by such computer systems enable them to implement the embodiments described herein. As used herein, the term “computer-readable media” refers to tangible memory storage devices having non-transient physical forms. Such non-transient physical forms may include computer memory devices, such as but not limited to: punch cards, magnetic disk or tape, any optical data storage system, flash read-only memory (ROM), non-volatile ROM, programmable ROM (PROM), erasable-programmable ROM (E-PROM), random-access memory (RAM), or any other form of permanent, semi-permanent, or temporary memory storage system of a device having a physical, tangible form. Program instructions include, but are not limited to, computer-executable instructions executed by computer system processors and hardware description languages such as Verilog or Very High-Speed Integrated Circuit (VHSIC) Hardware Description Language (VHDL).

As used herein, the terms “network function,” “framework,” “processor,” “controller,” “unit,” “model,” “core,” “server,” “node,” “module,” and similar phrases are used to describe computer processing components (e.g., processing circuitry) and/or one or more computer-executable services being executed on one or more computer processing components. In the context of this disclosure, such terms used in this manner would be understood by one skilled in the art to refer to specific network and/or computing elements and are not used as nonce word or intended to invoke 35 U.S.C. 112(f).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings, which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for cluster node activity-based anomaly detection, the system comprising:
one or more processors; and
one or more computer-readable media storing computer-usable instructions that, when executed by the one or more processors, cause the one or more processors to:
obtain a first indication of network data traffic comprising a baseline of network data traffic behaviors between a plurality of network nodes of a network cluster over a first time period, wherein individual nodes of the network cluster execute one or more network functions of a telecommunications network operator core network;
query one or more data logs of the plurality of network nodes to obtain a second indication of network data traffic associated with the network data traffic behaviors between the plurality of network nodes over a second time period;
identify one or more anomalous behaviors using one or more statistical algorithms to detect one or more deviations between the first indication of network data traffic and the second indication of network data traffic, wherein the one or more anomalous behaviors are associated with procedure transactions of the operator core network performed between the plurality of network nodes by the one or more network functions; and
generate an output comprising an indication of the one or more anomalous behaviors in response to the one or more deviations meeting at least a first trigger threshold.

2. The system of claim 1, wherein the one or more processors are comprised in a first node of the plurality of network nodes of the network cluster.

3. The system of claim 1, wherein the one or more processors are further to generate, using a machine learning algorithm, a prediction of the baseline of network data traffic behaviors based on one or more network node logs generated by the plurality of network nodes of the network cluster.

4. The system of claim 1, wherein the one or more processors are further to generate, using a machine learning algorithm, a prediction of the baseline of network data traffic behaviors based on one or more network function logs generated by the one or more network functions of the telecommunications network operator core network.

5. The system of claim 1, wherein the one or more processors are further to select the one or more statistical algorithms to be executed based on one or more procedure transaction profiles that indicate one or more nodes of the plurality of network nodes having at least one network function associated with a first procedure transaction of the operator core network.

6. The system of claim 5, wherein the one or more processors are further to parse through procedure transactions documented in the one or more data logs to identify the one or more anomalous behaviors.

7. The system of claim 1, wherein the network data traffic behaviors may include one or more of: data indicative of inbound and outbound data transmission rates, dropped packet counts, latency metrics, effective bandwidth, timeouts, internet protocol (IP) connections, or events occurring in traffic between the plurality of network nodes.

8. The system of claim 1, wherein the output identifies at least one of the one or more network functions associated with the one or more anomalous behaviors.

9. The system of claim 1, wherein the plurality of network nodes of the network cluster include at least one of: a network node of a radio access network coupled to the operator core network, or an edge server of a core network edge of the operator core network.

10. The system of claim 1, wherein one or more of the one or more network functions are executed by the network cluster as virtualized network functions.

11. The system of claim 1, wherein the one or more processors are further to trigger the telecommunications network to adjust operation of at least one of the plurality of network nodes based on the one or more anomalous behaviors.

12. A telecommunications network, the network comprising:
at least one wireless base station coupled to an operator core network, wherein the at least one wireless base station establishes one or more communication links between the operator core network and a user equipment (UE); and
one or more processors to perform one or more operations to:
generate a baseline prediction of network data traffic behaviors between a plurality of network nodes of a network cluster over a first time period, wherein individual nodes of the network cluster execute one or more network functions of the operator core network;
monitor one or more data logs of the plurality of network nodes to obtain an indication of network data traffic associated with the network data traffic behaviors between the plurality of network nodes over a second time period;
identify one or more anomalous data traffic behaviors associated with one or more procedure transactions of the operator core network performed by the one or more network functions based at least on one or more deviations between the baseline prediction of network data traffic behaviors and the indication of network data traffic determined using one or more statistical algorithms; and
control one or more operations of the operator core network in response to the one or more anomalous data traffic behaviors.

13. The network of claim 12, wherein the one or more processors further control one or more operations of the operator core network to:
generate an alert message in response to the one or more deviations meeting at least a first threshold; or
adjust operation of at least one of the plurality of network nodes based on the one or more anomalous data traffic behaviors.

14. The network of claim 12, wherein the one or more processors are comprised in a first node of the plurality of network nodes of the network cluster.

15. The network of claim 12, wherein the one or more processors are further to generate, using a machine learning algorithm, a prediction of the baseline of network data traffic behaviors based on one or more network node logs generated by the plurality of network nodes of a network cluster.

16. The network of claim 12, wherein the one or more processors are further to select the one or more statistical algorithms to be executed based on one or more procedure transaction profiles that indicate one or more nodes of the plurality of network nodes having at least one network function associated with a first procedure transaction of the operator core network.

17. The network of claim 12, wherein the network data traffic behaviors may include one or more of: data indicative of inbound and outbound data transmission rates, dropped packet counts, latency metrics, effective bandwidth, timeouts, internet protocol (IP) connections, or events occurring in traffic between the plurality of network nodes.

18. A method for cluster node activity-based anomaly detection, the method comprising:
generating a baseline of predicted network data traffic behaviors between a plurality of network nodes of a network cluster over a first time period, wherein individual nodes of the network cluster execute one or more network functions of an operator core network of a telecommunications system;
determining one or more anomalous behaviors based on one or more deviations in network data traffic behaviors between the plurality of network nodes over a second time period from the baseline of predicted network data traffic behaviors;
associating the one or more anomalous behaviors with one or more procedure transactions of the operator core network performed by the one or more network functions; and
adjusting one or more operations of the operator core network corresponding to the one or more procedure transactions in response to the one or more anomalous behaviors and based on the one or more deviations in network data traffic behaviors between the plurality of network nodes meeting at least a first trigger threshold.

19. The method of claim 18, the method further comprising generating the baseline of predicted network data traffic behaviors, using a machine learning algorithm, based on one or more network node logs generated by the plurality of network nodes of the network cluster for the first time period.

20. The method of claim 18, the method further comprising:
executing one or more statistical algorithms to detect the one or more deviations based on one or more procedure transaction profiles that indicate one or more nodes of the plurality of network nodes having at least one network function associated with a first procedure transaction of the operator core network.
